(19) United States
(12) Patent Application Publication
(10) Pub. No.: US 2024/0001736 A1
(43) Pub. Date: Jan. 4, 2024

(54) VEHICLE AND ARMREST

(71) Applicant: Panasonic Intellectual Property Management Co., Ltd., Osaka (JP)

(72) Inventors: Tsuyoshi NISHIO, Chiba Ken (JP); Toshihiro MIYAMICHI, Kanagawa Ken (JP)

(73) Assignee: Panasonic Intellectual Property Management Co., Ltd., Osaka (JP)

(21) Appl. No.: 18/120,784

(22) Filed: Mar. 13, 2023

(30) Foreign Application Priority Data
Jun. 30, 2022 (JP) 2022-106000

(51) Int. Cl. B60H 1/24; B60N 2/75; B60H 1/34; B60H 1/00

(52) U.S. Cl. CPC B60H 1/241; B60N 2/79; B60N 2/78; B60H 1/3435; B60H 1/00742; B60W 60/0053

(57) ABSTRACT

A vehicle according to the present disclosure includes a vehicle body, an armrest, a sensor, and an air blower port. The armrest is disposed along a side portion of a seat in the vehicle body. The armrest is disposed in the traveling direction. The armrest includes an upper surface on which an arm of a passenger sitting on the seat is allowed to rest. The sensor is provided on a side surface of the armrest. The sensor detects a hand of the passenger. The air blower port is provided on the side surface of the armrest and provided between the sensor and the upper surface of the armrest. The air blower sends out air from the armrest. The air sent out from the air blower port is changed on the basis of at least a detection result of the sensor.

### CROSS-REFERENCE TO RELATED APPLICATIONS

This application is based upon and claims the benefit of priority from Japanese Patent Application No. 2022-106000, filed on Jun. 30, 2022, the entire contents of which are incorporated herein by reference.

### FIELD

The present disclosure relates generally to a vehicle and an armrest.

### BACKGROUND

There is a disclosed technique of giving an awakening stimulus to the occupant by sending air from a headrest toward an occupant sitting on a seat of a vehicle (see, for example, JP 2007-176238 A).

However, the head of the occupant is not always located near the headrest, there is a possibility that the awakening stimulus cannot be appropriately given to the occupant.

### SUMMARY

A vehicle according to the present disclosure includes a pair of first wheels, a pair of second wheels, a vehicle body, a seat, an armrest, a sensor, and an air blower port. The vehicle body is coupled to the pair of first wheels and the pair of second wheels. The vehicle body is movable in a traveling direction by the pair of first wheels and the pair of second wheels. The seat is provided inside the vehicle body. The armrest is disposed along a side portion of the seat and disposed in the traveling direction. The armrest includes an upper surface on which an arm of a passenger sitting on the seat is allowed to rest. The sensor is provided on a side surface of the armrest, the sensor being configured to detect a hand of the passenger. The air blower port is provided on the side surface of the armrest and provided between the sensor and the upper surface of the armrest. The air blower is configured to send out air from the armrest. The vehicle is configured to change the air sent out from the air blower port on the basis of at least a detection result of the sensor.

### BRIEF DESCRIPTION OF THE DRAWINGS

FIG. 1 is a diagram schematically illustrating a vehicle according to an embodiment;

FIG. 2 is a schematic plan view of the vehicle according to the embodiment;

FIG. 3 is a schematic view of an internal structure of an armrest as viewed in a side direction of the vehicle according to the embodiment;

FIG. 4 is a view illustrating the armrest according to the embodiment as viewed from the front side;

FIG. 5 is a view illustrating the armrest according to the embodiment as viewed from above;

FIG. 6A is a view for explaining the movement of the armrest according to the embodiment;

FIG. 6B is a view for explaining the movement of the armrest according to the embodiment;

FIG. 6C is a view for explaining the movement of the armrest according to the embodiment;

FIG. 7 is a diagram for explaining a hardware configuration of the armrest ECU according to the embodiment;

FIG. 8 is a flowchart illustrating a procedure of switching processing from automated driving to manual driving according to the embodiment;

FIG. 9 is a flowchart illustrating a procedure of processing of an awakening means according to the embodiment;

FIG. 10 is a flowchart illustrating a procedure of an air blowing processing according to the embodiment;

FIG. 11 is a flowchart illustrating processing of directing an exhaust port to a position of a hand according to the embodiment;

FIG. 12 is a graph of sensor values when a position of a hand is changed according to the embodiment;

FIG. 13 is a flowchart illustrating a procedure of hand detection processing according to the embodiment;

FIG. 14 is a graph of sensor values at the time of hand detection according to the embodiment;

FIG. 15 is a flowchart illustrating a procedure of processing of checking the position of a hand according to the embodiment;

FIG. 16 is a flowchart illustrating a processing procedure for determining whether the driver is awakened by air blowing according to the embodiment;

FIG. 17 is a graph of sensor values for determining an awakening execution result according to the embodiment;

FIG. 18 is a flowchart illustrating a control procedure of manual operation according to the embodiment;

FIG. 19 is a schematic view of an armrest according to a modification;

FIG. 20 is a schematic view of an armrest according to a modification;

FIG. 21 is a perspective view of an armrest according to a modification;

FIG. 22 is a flowchart illustrating a procedure of processing of checking a position of a hand according to a modification;

FIG. 23 is a flowchart illustrating a procedure of hand detection processing according to the modification;

FIG. 24 is a flowchart illustrating an example of a procedure of an air blowing processing according to the modification; and

FIG. 25 is a flowchart illustrating an example of a procedure of an air blowing processing according to the modification.

### DETAILED DESCRIPTION

Hereinafter, embodiments of a vehicle and an armrest according to the present disclosure will be described with reference to the drawings.

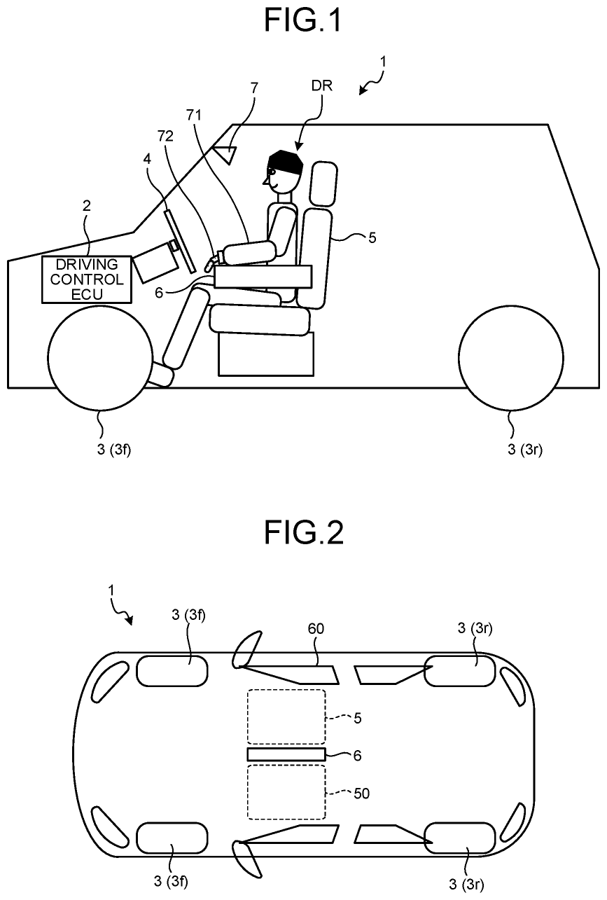

FIG. 1 is a diagram schematically illustrating a vehicle 1 according to the present embodiment. The vehicle 1 includes two pairs of wheels 3 (a pair of front tires 3f and a pair of rear tires 3r) disposed on the front and the rear of a vehicle body. The front tires 3f are an example of a pair of first wheels. The rear tires 3r are an example of a pair of second wheels.

The vehicle 1 is capable of traveling by using two pairs of wheels 3 arranged in a predetermined direction. In this case, the predetermined direction in which the two pairs of wheels 3 are arranged is the moving direction of the vehicle 1, and the vehicle 1 can move forward or backward by switching gears. As described above, the vehicle body of the vehicle 1 is coupled to the pair of front tires 3f and the pair of rear tires 3r, and is movable in the traveling direction by the pair of front tires 3f and the pair of rear tires 3r.

The vehicle 1 also includes a driving control ECU 2 and a steering wheel 4. The driving control ECU 2 is an in-vehicle system that controls driving of the vehicle 1 driven by the driver DR. For example, the driving control ECU 2 performs automated driving control of the vehicle 1 in accordance with a route to a destination. Note that the vehicle 1 sets a route by using a navigation device (not illustrated) or the like.

When executing the automated driving, the driving control ECU 2 executes the automated driving by controlling a steering actuator, a throttle actuator, and a brake actuator (not illustrated). The driving control ECU 2 executes automated driving by using a current position obtained by the GPS receiver and an imaging result obtained by a vehicle exterior imaging unit (not illustrated). The driving control ECU 2 also executes automated driving by using a vehicle speed sensor, a distance measuring sensor, a gyro sensor, a steering angle sensor, and the like.

Moreover, the driving control ECU 2 executes switching control between automated driving and manual driving. The driving control ECU 2 switches from automated driving to manual driving at the timing when the vehicle 1 arrives at the destination of a route. The driving control ECU 2 may switch from the automated driving to the manual driving in accordance with a switch operation of the steering wheel 4 or the like.

The driving control ECU 2 may implement all the functions by software or may implement part of the functions by hardware.

In the interior of the vehicle 1, a seat 5 on which a passenger (for example, the driver DR) of the vehicle 1 can sit is provided. For example, the seat 5 is a driver's seat on which the driver DR sits. The driver DR can perform a manual driving operation by operating the steering wheel 4 or operating an accelerator pedal and a brake pedal (not illustrated) while sitting on the seat 5, thereby operating the vehicle 1.

An armrest 6 is provided at a side portion of the seat 5. The armrest 6 is disposed along the side portion of the seat 5 and disposed in the traveling direction. The armrest 6 has an upper surface on which an arm 71 of a passenger (for example, the driver DR) sitting on the seat 5 is allowed to rest. As illustrated in FIG. 2, the vehicle 1 further includes a seat 50 (passenger seat) adjacent to the seat 5 as the driver's seat in a direction intersecting the traveling direction. In this example, the seat 5 as the driver's seat corresponds to a “first seat”, and the seat 50 as the passenger seat corresponds to a “second seat”. As illustrated in FIG. 2, the armrest 6 is disposed between the seat 5 (first seat) and the seat 50 (second seat) in the traveling direction. Note that the arrangement of the armrest 6 is not limited to the example of FIG. 2. For example, the armrest 6 may be provided on a door 60 beside the seat 5 (that is, the side opposite to the seat 50 in the direction intersecting the traveling direction).

In a case where the vehicle 1 is in automated driving and the driver DR releases his/her hand from the steering wheel 4, the arm 71 of the driver DR can be placed on the upper surface of the armrest 6. When the driver DR places the arm 71 on the upper surface of the armrest 6, a hand 72 is located near the front end surface in the traveling direction among the side surfaces of the armrest 6. The armrest 6 may be moved upward about a connection portion with the seat 5. For example, if the armrest 6 is moved upward during manual driving, it is possible to prevent the arm 71 of the driver DR from hitting the armrest 6 when the driver DR performs a manual driving operation.

The armrest 6 may include an armrest sensor that detects whether the armrest is used. The armrest sensor is a sensor for detecting whether the armrest 6 is moved upward.

In addition, a vehicle interior imaging unit 7 is provided in the vehicle interior of the vehicle 1. The vehicle interior imaging unit 7 captures an image of the driver DR The captured image is subjected to image analysis by the driving control ECU 2 to determine the state of the driver DR, for example, determine whether the driver is inattentive or dozing.

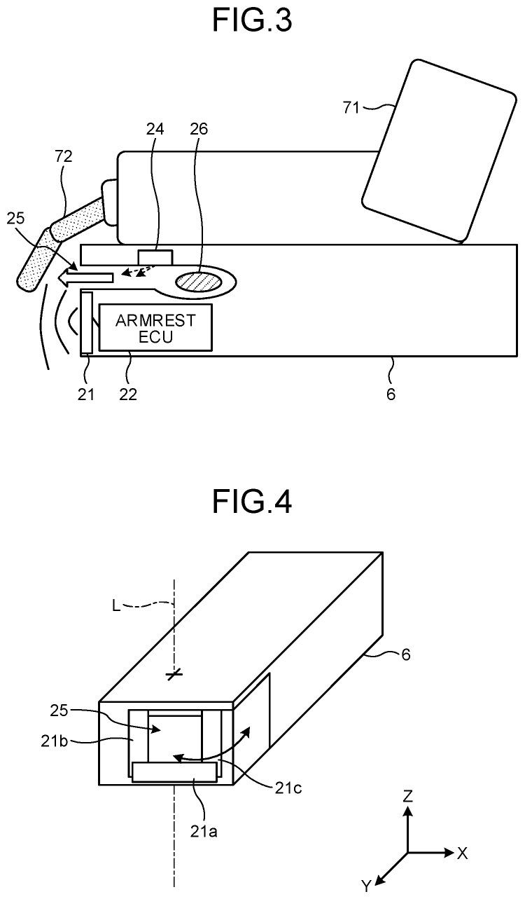

Next, the armrest 6 according to the present embodiment will be described with reference to FIG. 3. FIG. 3 is a schematic view of an internal structure of the armrest 6 as viewed in a side direction of the vehicle 1. As illustrated in FIG. 3, the armrest 6 includes an electrostatic sensor 21, an armrest ECU 22, an electrostatic atomization device 24, and a fan 26.

The electrostatic sensor 21 is an example of a “sensor”. The electrostatic sensor 21 is provided on a side surface of the armrest 6, and is preset to detect a hand of a passenger (for example, the driver DR). In the present embodiment, the armrest 6 is provided with the electrostatic sensor 21 on a lower portion of a front end surface in a traveling direction among side surfaces of the armrest 6. A detection result (a signal indicating a sensing result) from the electrostatic sensor 21 is transmitted to the armrest ECU 22. As a method by which the armrest ECU 22 detects the hand 72 located near the electrostatic sensor 21 on the basis of the detection result of the electrostatic sensor 21, for example, there is a method of applying the technology described in JP 2015-18574 A. An air blower port 25, through which air is sent out from the armrest 6, is provided on a side surface of the armrest 6 between the upper surface and the electrostatic sensor 21.

The armrest ECU 22 integrally controls the armrest 6. The armrest ECU 22 changes the air sent out from the air blower port 25 on the basis of at least a detection result of the electrostatic sensor 21. In the present embodiment, in response to detecting that the hand 72 is located near the electrostatic sensor 21 on the basis of a signal received from the electrostatic sensor 21, the armrest ECU 22 operates the fan 26 to output air from the air blower port 25. The fan 26 is an example of an air blower mechanism that supplies air from the inside of the armrest 6 to the air blower port 25. The armrest ECU 22 is an example of a control circuit that operates the air blower mechanism on the basis of a detection result of a sensor (in this example, the electrostatic sensor 21). In response to detecting that the hand 72 is located near the electrostatic sensor 21 on the basis of a signal received from the electrostatic sensor 21, the armrest ECU 22 may operate the electrostatic atomization device 24 to output charged particulate water from the air blower port 25.

FIG. 4 illustrates the armrest 6 as viewed from the front side. As illustrated in FIG. 4, the armrest 6 includes not only an electrostatic sensor 21a at the lower portion of the air blower port 25 but also an electrostatic sensor 21b and an electrostatic sensor 21c on the left and right sides of the air blower port 25, respectively. In the example of FIG. 4, the electrostatic sensor 21b provided on the left of the air blower port 25 is an example of a “third sensor”, and the electrostatic sensor 21c provided on the right of the air blower port is an example of a “fourth sensor”.

The armrest ECU 22 performs control such that the electrostatic sensors 21a to 21c and the air blower port 25 integrally rotate about the axis L. In the present embodiment, the armrest ECU 22 moves the air blower port 25 toward the electrostatic sensor 21b or the electrostatic sensor 21c that has detected the hand 72.

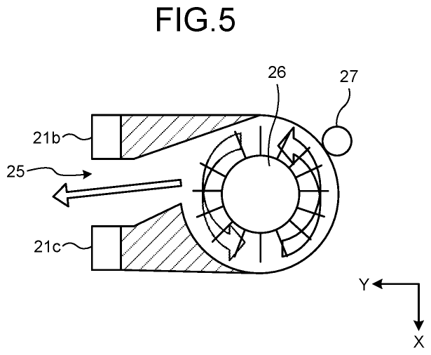

FIG. 5 illustrates the armrest 6 as viewed from the upper surface side. As illustrated in FIG. 5, the armrest ECU 22 outputs air from the air blower port 25 to the outside by rotating the fan 26. Therefore, the fan 26 functions as an air blower mechanism. The armrest 6 includes a wind direction actuator 27. The armrest ECU 22 operates the wind direction actuator 27 to change the wind direction by changing the direction of the air blower port 25.

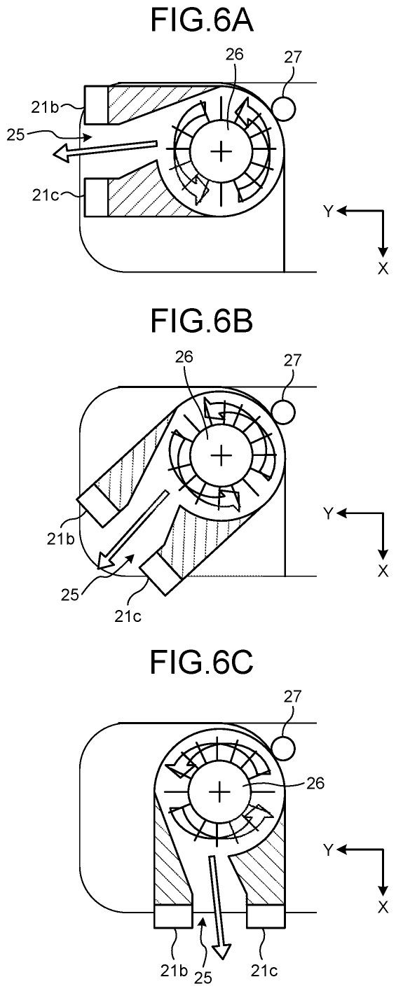

Next, an example of changing the direction of the air blower port 25 of the armrest 6 will be described with reference to FIGS. 6A to 6C. The Y direction illustrated in FIGS. 6A to 6C indicates the traveling direction. In this example, the wind direction actuator 27 functions as a moving mechanism that moves the air blower port 25 between a first portion as a front end portion of the armrest 6 in the traveling direction and a second portion as a portion of the armrest 6 extending in the traveling direction.

FIG. 6A exemplifies a case where the air blower port 25 is located in the first portion of the side surface of the armrest 6. The first portion corresponds the front end of the armrest 6 in the traveling direction. It can be understood as an example of a case where the side surface of the armrest 6, on which the air blower port 25 and the electrostatic sensor 21 are provided, is a surface located at a front end of the armrest 6 in the traveling direction. In this state, when the hand 72 is located on the electrostatic sensor 21c side, the armrest ECU 22 operates the wind direction actuator 27 to change the direction of the air blower port 25 of the armrest 6 in the order of FIGS. 6B and 6C. FIG. 6C exemplifies a case where the air blower port 25 is located in the second portion being a portion of the side surface of the armrest 6 extending in the traveling direction. It can be understood as an example of a case where the side surface of the armrest 6, on which the air blower port 25 and the electrostatic sensor 21 are provided, is a surface of the armrest 6 extending in the traveling direction. In this manner, the armrest ECU 22 moves the air blower port 25 from the first portion to the second portion of the armrest 6.

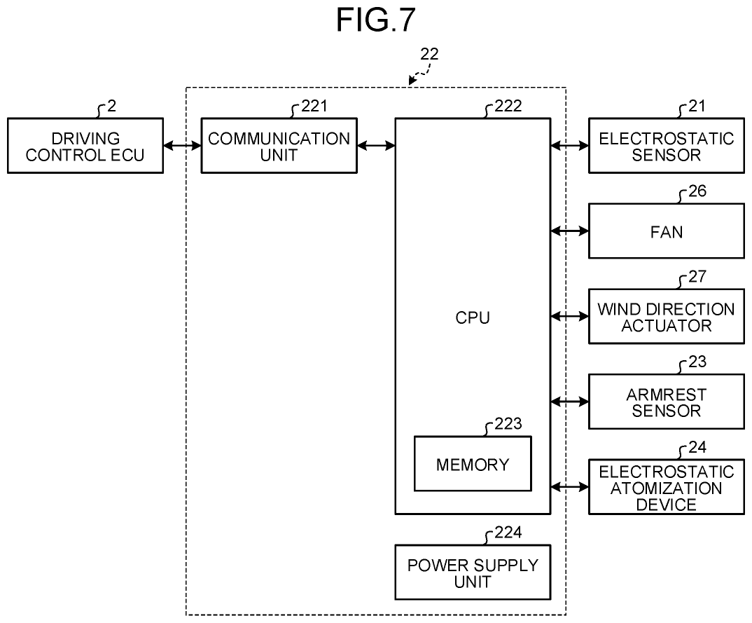

Next, a hardware configuration of the armrest ECU 22 will be described with reference to FIG. 7. The armrest ECU 22 is connected to the driving control ECU 2, the electrostatic sensor 21, the fan 26, the wind direction actuator 27, an armrest sensor 23, and the electrostatic atomization device 24.

The armrest ECU 22 includes a communication unit 221, a CPU 222, a memory 223, and a power supply unit 224. The communication unit 221 transmits and receives data to and from the driving control ECU 2 via a local interconnect network (LIN) or via a controller area network (CAN). The CPU 222 is a circuit that controls the armrest ECU 22. The memory 223 stores various pieces of data. The CPU 222 executes various processes by executing the program stored in the memory 223. The CPU 222 is an example of a processor. The memory 223 is, for example, a RAM or the like. The power supply unit 224 is a power supply circuit of the armrest ECU 22.

The armrest ECU 22 determines whether the armrest is in use, on the basis of the signal received from the armrest sensor 23. The armrest ECU 22 determines whether the hand 72 is located near the electrostatic sensor 21, on the basis of the signal received from the electrostatic sensor 21. The armrest ECU 22 transmits a control signal to the wind direction actuator 27 on the basis of a signal received from the electrostatic sensor 21 to operate the wind direction actuator 27.

The armrest ECU 22 operates the fan 26 or the electrostatic atomization device 24 on the basis of a signal received from the electrostatic sensor 21. When a signal received from the driving control ECU 2 indicates that the automated driving is switched to the manual driving, the armrest ECU 22 may operate the fan 26 or operate the electrostatic atomization device 24 on the basis of the signal received from the electrostatic sensor 21.

Description of Operation Processing

Next, the awakening processing by the vehicle 1 will be described. As the awakening processing, the vehicle 1 executes multiple pieces of awakening processing such as processing of outputting air from the armrest 6 and processing of outputting a warning sound. The vehicle 1 executes the awakening processing at a timing when the automated driving state is switched to the manual driving.

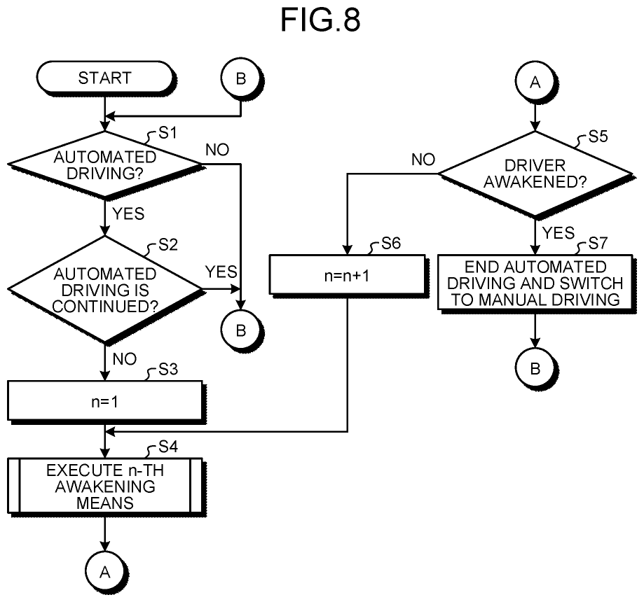

First, a procedure of switching processing from automated driving to manual driving will be described with reference to FIG. 8. The driving control ECU 2 determines whether the vehicle is in automated driving (Step S1). The driving control ECU 2 proceeds to Step S1 in response to determining that the vehicle is not in automated driving (Step S1: No).

On the other hand, in response to determining that the automated driving is being performed (Step S1: Yes), the driving control ECU 2 determines whether to continue the automated driving (Step S2). For example, when the vehicle has not arrived at the destination of a preset route, the driving control ECU 2 determines that the automated driving is continued (Step S2: Yes). The driving control ECU 2 proceeds to Step S1 in response to determining that the automated driving is continued. When the vehicle 1 arrives at the destination of the preset route, the driving control ECU 2 determines that the automated driving is not continued (Step S2: No). In response to determining that the automated driving is not continued (Step S2: No), the driving control ECU 2 sets the value n to 1 (Step S3). Then, the driving control ECU 2 executes the n-th awakening means (Step S4).

After executing the n-th awakening means, the driving control ECU 2 determines whether the driver is awakened (Step S5). In a case where the driver is not awakened (Step S5: No), the driving control ECU 2 counts up the value n (Step S6) and proceeds to Step S4. In response to determining in Step S5 that the driver is awakened (Step S5: Yes), the driving control ECU 2 terminates the automated driving and switches to the manual driving (Step S7).

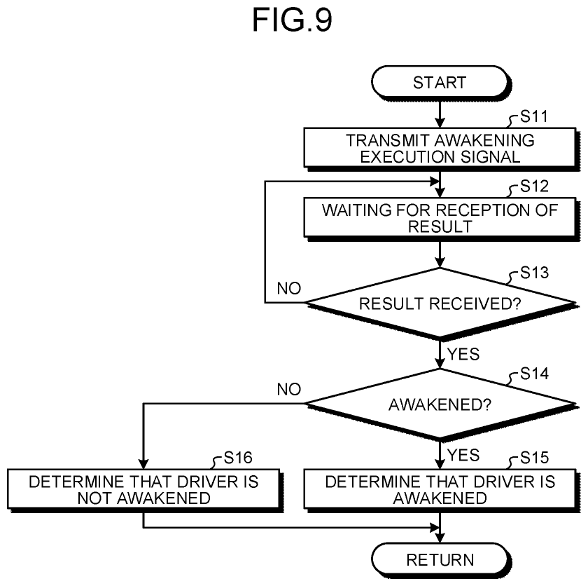

Next, processing contents of Step S4 in FIG. 8 will be described with reference to a flowchart illustrated in FIG. 9. FIG. 9 is a flowchart illustrating a procedure of processing of the awakening means.

The driving control ECU 2 transmits a signal indicating execution of awakening to an ECU (for example, the armrest ECU 22) that executes the awakening processing (Step S11). The driving control ECU 2 then waits for reception of a result from the transmission destination ECU (Step S12). The driving control ECU 2 proceeds to Step S12 when the result has not been received (Step S13: No). When the result has been received (Step S13: Yes), the driving control ECU 2 makes reference to the received result. In a case where the result indicates that the driver is awakened (Step S14; Yes), the driving control ECU 2 determines that the driver can be awakened, and finishes the processing (Step S15). In a case where the result does not indicate that the driver is awakened (Step S14: No), the driving control ECU 2 determines that the driver cannot be awakened, and finishes the processing (Step S16).

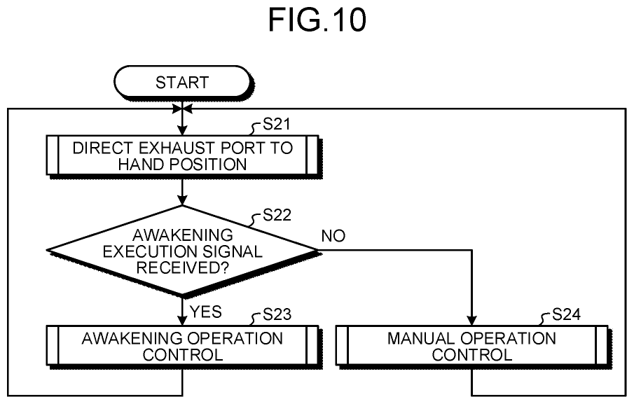

Hereinafter, description will be given with focusing on processing of outputting air as the awakening means. A processing procedure for outputting air by the armrest ECU 22 will be described with reference to FIG. 10. FIG. 10 is a flowchart illustrating a procedure of the air blowing processing. The armrest ECU 22 detects the position of the hand 72 and causes the air blower port 25 to follow the position of the hand 72 (Step S21). Subsequently, in a case where the signal indicating the execution of awakening has been received from the driving control ECU 2 (Step S22: Yes), the armrest ECU 22 executes the awakening operation control (Step S23). In a case where the signal indicating the execution of awakening has not been received from the driving control ECU 2 (Step S22: No), the armrest ECU 22 executes manual operation control (Step S24).

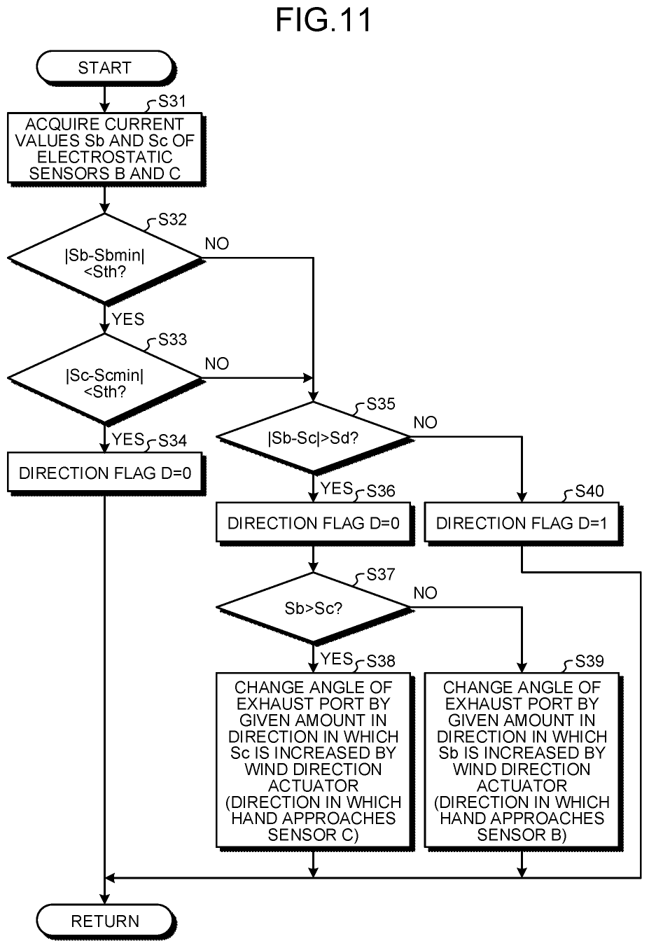

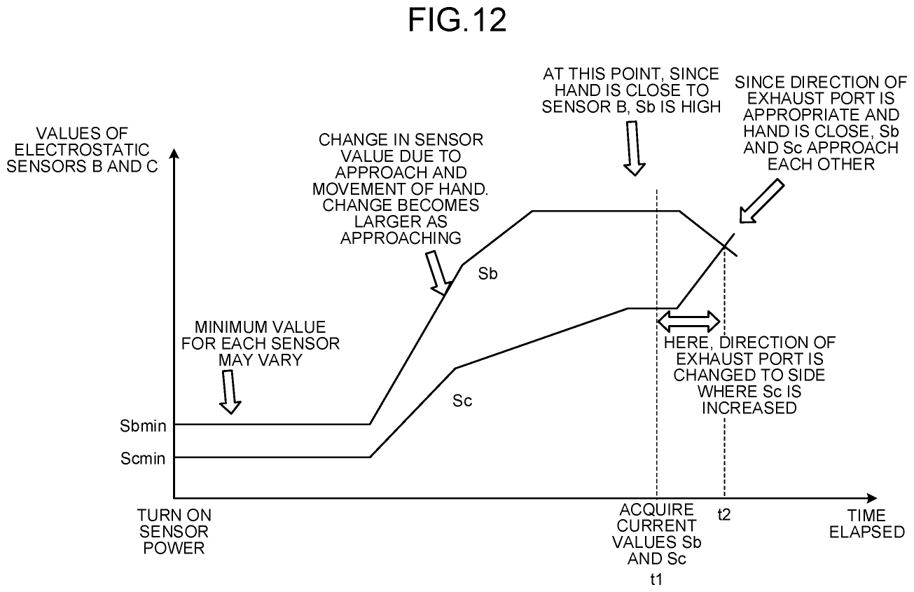

Next, detailed processing in Step S21 illustrated in FIG. 10 will be described with reference to FIGS. 11 and 12. FIG. 11 is a flowchart illustrating processing of directing the exhaust port to the position of the hand. FIG. 12 is a graph illustrating sensor values of the processing of the flowchart illustrated in FIG. 11.

The electrostatic sensor 21b and the electrostatic sensor 21c will be described as an electrostatic sensor B and an electrostatic sensor C, respectively. The armrest ECU 22 acquires a value Sb and a value Sc that are current values of the electrostatic sensor B and the electrostatic sensor C, respectively (Step S31). Subsequently, the armrest ECU 22 determines whether the absolute value of the difference value between the value Sb and the value Sbmin is less than the value Sth (Step S32).

As illustrated in FIG. 12, the value Sbmin is a value obtained when the electrostatic sensor B is turned on. The value Scmin is a value obtained when the electrostatic sensor C is turned on. The value Sth is a threshold value for determining whether an object such as the hand 72 has been detected.

As illustrated in FIG. 12, in a case where there is a difference between the value Sb and the value Sbmin (for example, time t1), it indicates that the hand 72 is detected. In addition, in a case where there is a difference between the value Sc and the value Scmin (for example, time t1), it indicates that the hand 72 is detected.

Returning to FIG. 11, the armrest ECU 22 proceeds to Step S33 in response to determining that the absolute value of the difference value between the value Sb and the value Sbmin is less than the value Sth (Step S32: Yes). The armrest ECU 22 proceeds to Step S35 in response to determining that the absolute value of the difference value between the value Sb and the value Sbmin is not less than the value Sth (Step S32: No).

In Step S33, the armrest ECU 22 determines whether the absolute value of the difference value between the value Sc and the value Scmin is less than the value Sth (Step S33). The armrest ECU 22 proceeds to Step S34 in response to determining that the absolute value of the difference value between the value Sc and the value Scmin is less than the value Sth (Step S33: Yes). The armrest ECU 22 proceeds to Step S35 in response to determining that the absolute value of the difference value between the value Sc and the value Scmin is not less than the value Sth (Step S33: No).

Proceeding to Step S34 represents that neither the electrostatic sensor B nor the electrostatic sensor C has detected the hand 72, so that the armrest ECU 22 sets the direction flag D to 0 (Step S34).

Proceeding to Step S35 represents that the electrostatic sensor B or the electrostatic sensor C has detected the hand 72. In Step S35, the armrest ECU 22 determines whether the absolute value of the difference between the value Sb and the value Sc exceeds the value Sd (Step S35). The value Sd is a value for determining which of the electrostatic sensor B and the electrostatic sensor C is approached by the hand 72.

In response to determining that the absolute value of the difference between the value Sb and the value Sc exceeds the value Sd (Step S35: Yes), the armrest ECU 22 sets the direction flag D to 0 (Step S36). In Step S37, in a case where the value Sb is larger than the value Sc (Step S37: Yes), the armrest ECU 22 operates the wind direction actuator 27 to direct the air blower port 25 in the orientation where the hand 72 approaches the electrostatic sensor C (Step S38). In a case where the value Sb is not larger than the value Sc in Step S37 (Step S37: No), the armrest ECU 22 operates the wind direction actuator to operate the air blower port 25 in the orientation where the hand 72 approaches the electrostatic sensor B (Step S39). After that, the processing may proceed to Step S31.

As illustrated in FIG. 12, when the difference between the current value Sb and the current value Sc is large (time t1), the armrest ECU 22 causes the air blower port 25 to operate such that the value Sc increases. As a result, the value Sb and the value Sc approach each other (time t2). In this manner, the armrest ECU 22 can bring the air blower port 25 close to the position of the hand 72.

Returning to FIG. 11, in response to determining in Step S35 that the absolute value of the difference between the value Sb and the value Sc does not exceed the value Sd (Step S35: No), the armrest ECU 22 sets the direction flag D to 1 (Step S40).

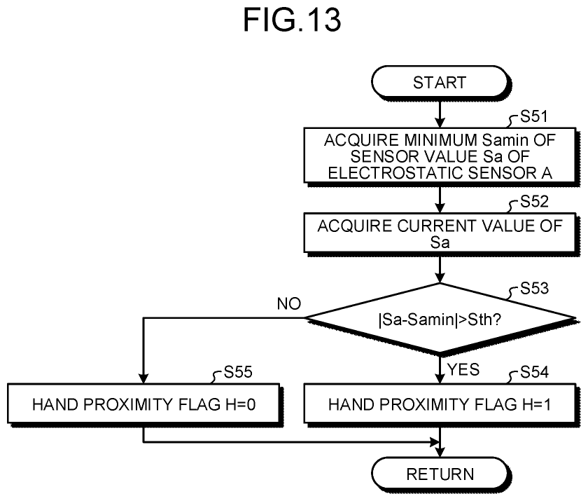

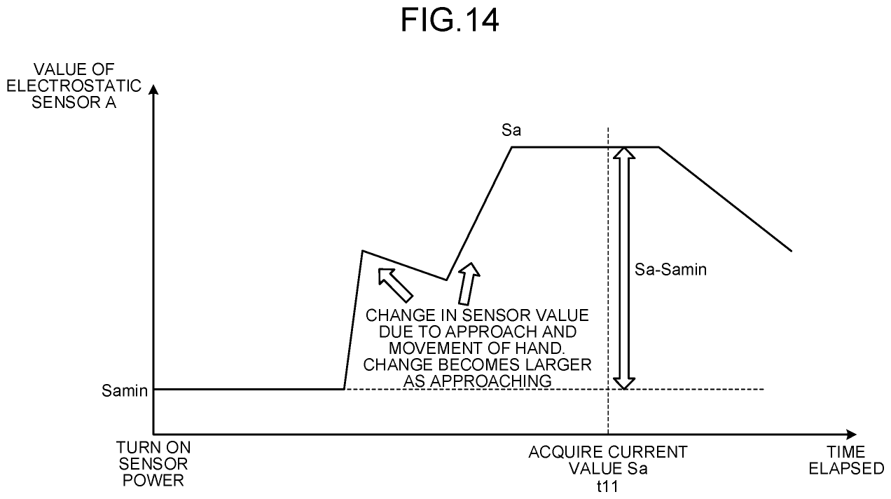

Next, the awakening operation control in Step S23 of the flowchart in FIG. 10 will be described with reference to FIGS. 13 to 17. The armrest ECU 22 executes processing of detecting the hand 72 when performing the awakening operation. The hand detection processing procedure will be described with reference to FIGS. 13 and 14.

FIG. 13 is a flowchart illustrating a procedure of hand detection processing. The electrostatic sensor 21a will be described as an electrostatic sensor A. The armrest ECU 22 acquires a value Samin (value at power-on) that is the minimum value of a value Sa of the electrostatic sensor A (Step S51). Note that the armrest ECU 22 may store in advance the value Samin of the electrostatic sensor A in the memory 223 and acquire the stored value Samin.

The armrest ECU 22 acquires the current value Sa of the electrostatic sensor A (Step S52). Subsequently, the armrest ECU 22 determines whether the absolute value of the difference between the value Sa and the value Samin exceeds the value Sth (Step S53). In response to determining that the absolute value of the difference between the value Sa and the value Samin exceeds the value Sth (Step S53: Yes), the armrest ECU 22 sets the hand proximity flag H to 1 (Step S54). In response to determining that the absolute value of the difference between the value Sa and the value Samin does not exceed the value Sth (Step S53: No), the armrest ECU 22 sets the hand proximity flag H to 0 (Step S55).

FIG. 14 is a graph illustrating change in the value Sa. The value Sa at the timing when the power is turned on is the value Samin. The armrest ECU 22 acquires the current value Sa (time t11), and sets the hand proximity flag H to 1 when the absolute value of the difference between the value Sa and the value Samin exceeds the value Sth.

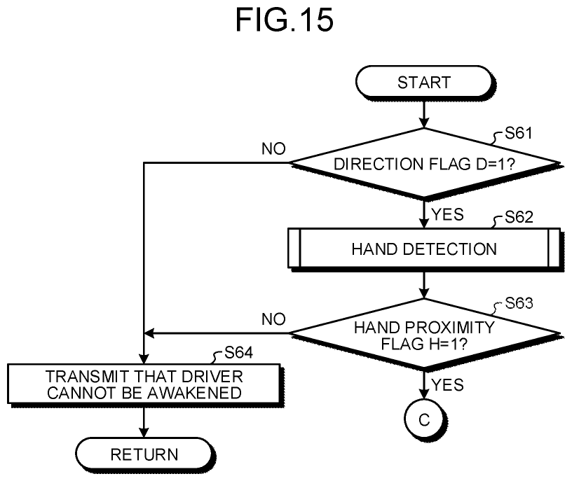

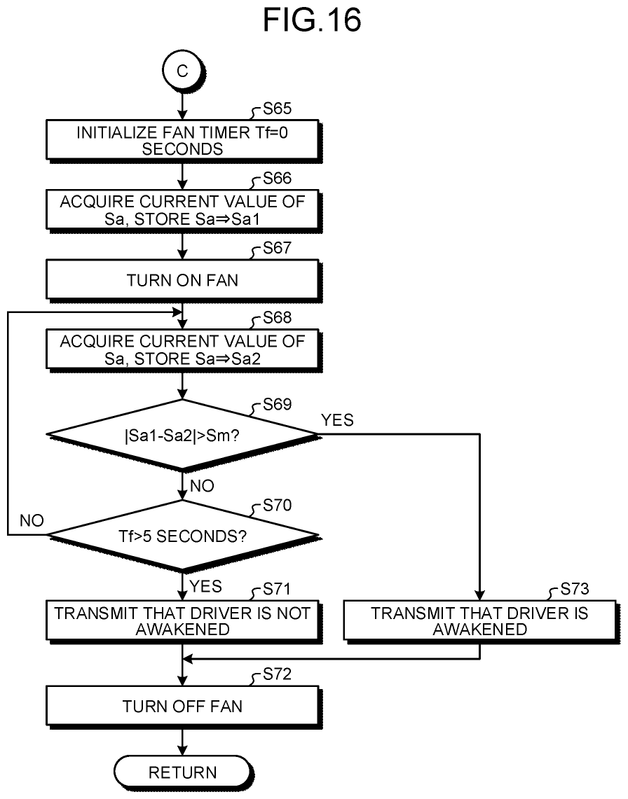

Subsequently, the processing procedure of the awakening operation control in Step S23 of the flowchart illustrated in FIG. 10 will be described with reference to FIGS. 15 and 16.

FIG. 15 illustrates processing for checking the position of the hand 72. The armrest ECU 22 determines whether the direction flag D is 1 (Step S61). In a case where the direction flag D is not 1 (Step S61: No), it indicates that the hand 72 cannot be followed. In this case, the armrest ECU 22 transmits, to the driving control ECU 2, a signal indicating that the driver cannot be awakened (Step S64).

In response to determining that the direction flag D is 1 (Step S61: Yes), the armrest ECU 22 performs a hand detection processing (Step S62). Details of the hand detection processing are as illustrated in the processing procedure of FIG. 13. In a case where the proximity flag H is 1 as a result of the hand detection processing (Step S63: Yes), the armrest ECU 22 proceeds to Step S65 in the flowchart illustrated in FIG. 16. In a case where the proximity flag H is not 1 as a result of the hand detection processing (Step S63: No), the armrest ECU 22 proceeds to Step S64.

FIG. 16 is a flowchart illustrating a processing procedure for determining whether the driver is awakened by air blowing. In Step S65, the armrest ECU 22 initializes the fan timer Tf to 0 seconds (Step S65). Subsequently, the armrest ECU 22 acquires the current value of the value Sa, which is the value of the electrostatic sensor A, and stores the current value as the value Sa1 (Step S66).

The armrest ECU 22 turns on the fan 26 (Step S67). Subsequently, the armrest ECU 22 acquires the current value of the value Sa and stores the acquired current value as the value Sa2 (Step S68). Subsequently, the armrest ECU 22 determines whether the absolute value of the difference value between the value Sa1 and the value Sa2 exceeds the value Sm (Step S69).

In response to determining that the absolute value of the difference value between the value Sa1 and the value Sa2 exceeds the value Sm (Step S69: Yes), the armrest ECU 22 transmits a signal indicating that the driver is awakened to the driving control ECU 2 (Step S73) and turns off the fan 26 (Step S72). The value Sm is a value indicating a change amount of the value of the electrostatic sensor A. The absolute value of the difference value between the value Sa1 and the value Sa2 exceeding the value Sm indicates a change from a state where the hand 72 is detected to a state where the hand 72 cannot be detected. As described above, the armrest 6 outputs the signal indicating whether the driver is awakened, on the basis of the result of comparison between the detection result of the electrostatic sensor A before the fan 26 is operated and the detection result of the electrostatic sensor A after the fan 26 is operated. That is, in the present embodiment described above, the detection result of the electrostatic sensor A when the proximity flag H is 1 is set as the first detection result, and the armrest ECU 22 changes the air sent out from the air blower port 25 on the basis of the first detection result. Then, the armrest ECU 22 estimates the awakening state of the driver (passenger) on the basis of the subsequent second detection result of the electrostatic sensor A (in this example, the detection result after the fan 26 is operated). As a result, the armrest 6 can appropriately determine whether the driver is awakened and output the determination result.

On the other hand, in response to determining that the absolute value of the difference value between the value Sa1 and the value Sa2 does not exceed the value Sm (Step S69: No), the armrest ECU 22 determines whether the fan timer Tf exceeds 5 seconds (Step S70). In response to determining in Step S70 that the fan timer Tf does not exceed 5 seconds (Step S70: No), the armrest ECU 22 proceeds to Step S68. In response to determining in Step S70 that the fan timer Tf exceeds 5 seconds (Step S70: Yes), the armrest ECU 22 transmits a signal indicating that the driver is not awakened to the driving control ECU 2 (Step S71) and turns off the fan 26 (Step S72).

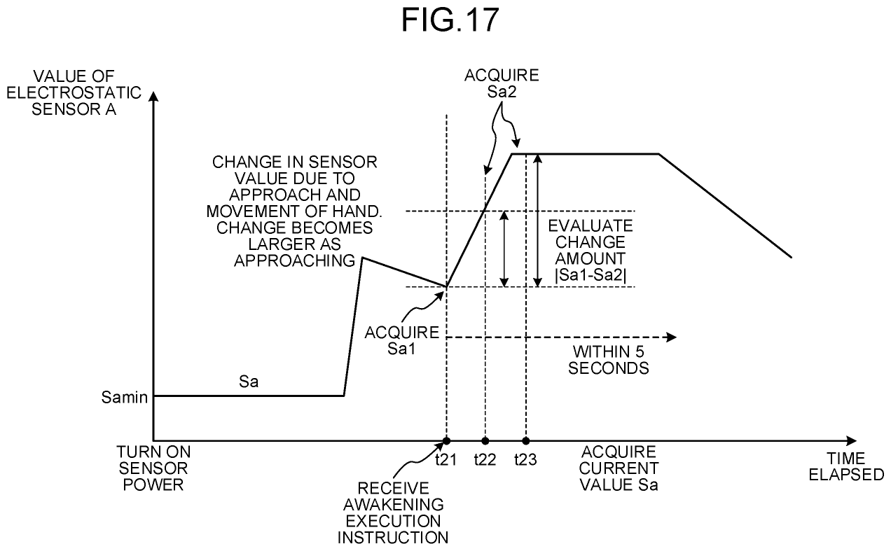

Next, FIG. 17 is a graph illustrating change in the value Sa. The value Sa at the timing when the power is turned on is the value Samin. Upon receiving the signal indicating the execution of awakening, the armrest ECU 22 acquires a current value Sa1 (time t21) and further acquires a value Sa2 after a while (time t22 and t23). The armrest ECU 22 calculates an absolute value (change amount) of a difference value between the value Sa1 and the value Sa2. Then, the armrest ECU 22 determines whether the driver has been awakened, on the basis of the calculated change amount.

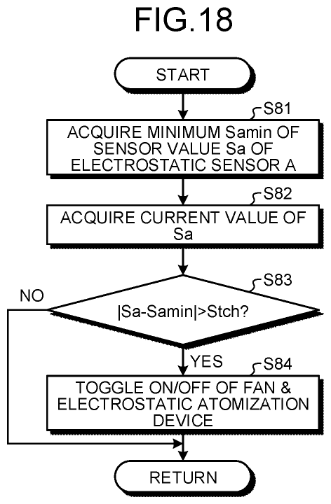

Next, the manual operation control in Step S24 of the flowchart of FIG. 10 will be described with reference to FIG. 18.

FIG. 18 is a flowchart illustrating a manual operation control procedure. The armrest ECU 22 acquires a value Samin that is the minimum value of a value Sa of the electrostatic sensor A (Step S81).

The armrest ECU 22 acquires the current value Sa of the electrostatic sensor A (Step S82). Subsequently, the armrest ECU 22 determines whether the absolute value of the difference between the value Sa and the value Samin exceeds the value Stch (Step S83). In response to determining that the absolute value of the difference between the value Sa and the value Samin exceeds the value Stch (Step S83: Yes), the armrest ECU 22 toggles on/off to operate the fan 26 and the electrostatic atomization device 24 (Step S84). The value Stch is a value indicating that the hand 72 has come into contact with the electrostatic sensor A, and is larger than the value Sth.

In this manner, the armrest ECU 22 performs control to repeat the operation/stop of the fan 26 on the basis of the detection result of the electrostatic sensor A. As a result, the armrest ECU 22 is able to enhance the awakening effect as compared with the case of simply continuing the operation of the fan 26. In response to determining that the absolute value of the difference between the value Sa and the value Samin does not exceed the value Stch (Step S83: No), the armrest ECU 22 ends the processing without driving the fan 26.

As described above, the armrest 6 includes the fan 26, the air blower port 25 for sending out air from the armrest 6, the electrostatic sensor 21 for detecting the hand 72 of the driver DR, and the armrest ECU 22. In the armrest 6, the armrest ECU 22 operates the fan 26 on the basis of the detection result of the electrostatic sensor 21, thereby outputting air from the air blower port 25. In this manner, the armrest 6 outputs air on condition that the hand 72 is located near the armrest 6. Therefore, it is possible to appropriately give an awakening stimulus.

In addition, the armrest 6 includes the wind direction actuator 27 and the electrostatic sensors 21b and 21c located on the left and right sides of the air blower port 25. The wind direction actuator 27 moves the air blower port 25 between the first portion and the second portion of the armrest 6. The first portion is the front end in the traveling direction of the side surface of the armrest 6. The second portion is a portion of the armrest 6 extending in the traveling direction. The air blower port 25 is moved toward the electrostatic sensor 21b or the electrostatic sensor 21c that has detected the hand 72. The armrest 6 causes the air blower port 25 to follow the position of the hand 72 and outputs air, so that it is possible to more reliably give an awakening stimulus.

Moreover, the armrest 6 changes the air sent out from the air blower port 25 on the basis of the timing at which the automated driving is switched to the manual driving. More specifically, the armrest ECU 22 operates the fan 26 such that the air sent out from the air blower port 25 changes, on the basis of the timing at which the automatic operation is switched to the manual operation. In the case of automated driving, the driver DR does not need to perform a steering operation, and thus it is conceivable that the driver DR places an arm on the armrest 6. When the automated driving is switched to the manual driving, it is necessary to notify the driver DR that the driving is switched to the manual driving to prepare for the manual driving. Therefore, by the armrest 6 operating the fan 26 such that the volume of the air sent out from the air blower port 25 increases at the timing when the automated driving is switched to the manual driving, it is possible to give an awakening stimulus to the driver DR, and thus, it is possible to prompt the driver DR to prepare for the manual driving.

### Modification

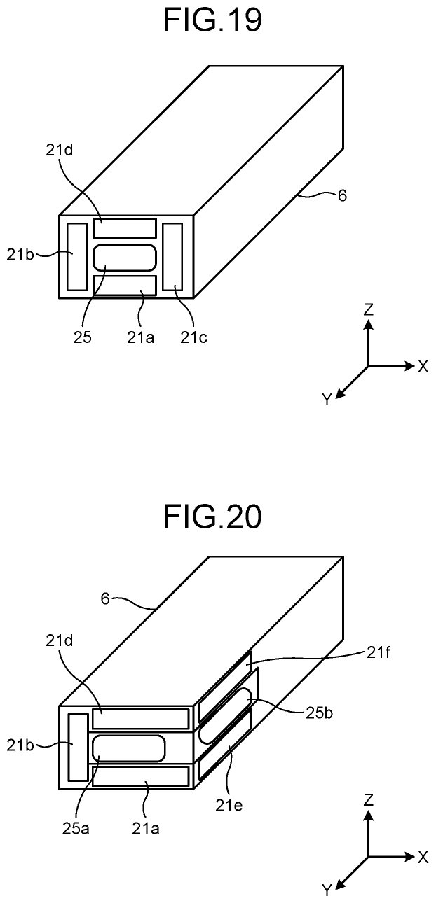

In the embodiment described above, the air blower port 25 is movable. However, as illustrated in FIG. 19, the air blower port 25 may be fixed to the front surface of the armrest 6.

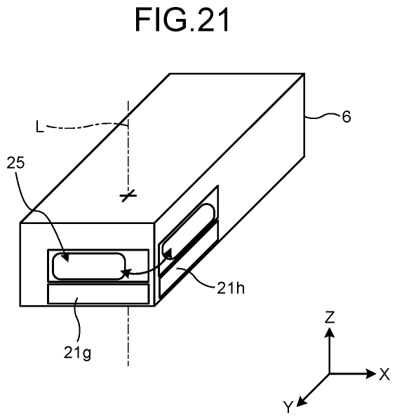

In addition, as illustrated in FIG. 20, an air blower port 25a may be provided in the front surface of the armrest 6, an air blower port 25b may be provided in the side surface of the armrest 6, the electrostatic sensor 21a may be provided below the air blower port 25a, and an electrostatic sensor 21e may be provided below the air blower port 25b. Then, the armrest 6 may switch the air blower port 25 for outputting air on the basis of the detection results from the electrostatic sensor 21a and the electrostatic sensor 21e.

In the embodiment described above, the air blower port 25 is selectively disposed at the first portion or the second portion of the armrest 6 by operating the wind direction actuator 27 on the basis of the detection results from the electrostatic sensors 21b and 21c. Alternatively, as illustrated in FIG. 20, the electrostatic sensor 21e may be provided at the lower portion of the side surface of the armrest 6. In this configuration, the wind direction actuator 27 may be operated to move the air blower port 25 on the basis of the detection results from the electrostatic sensor 21a and the electrostatic sensor 21e.

The armrest 6 with the above configuration can move the air blower port 25 so as to follow the position of the hand 72, on the basis of the detection results from the electrostatic sensor 21a and the electrostatic sensor 21e, and can appropriately give an awakening stimulus.

In the above embodiment, the electrostatic sensors 21b and 21c are movable integrally with the air blower port 25. The present disclosure is not limited thereto. The electrostatic sensor 21 may be provided apart from the air blower port 25. For example, as illustrated in FIG. 21, the electrostatic sensor 21 may include an electrostatic sensor 21g (first sensor) provided in the first portion being a front end portion in the traveling direction of the side surface of the armrest 6, and an electrostatic sensor 21h (second sensor) provided in the second portion being a portion of the armrest 6 extending in the traveling direction. In the example of FIG. 21, the electrostatic sensor 21g is provided below the first portion, and the electrostatic sensor 21h is provided below the second portion. However, the arrangement of the electrostatic sensors 21g and 21h can be optionally changed in accordance with design conditions and the like. In the example of FIG. 21, as in the above-described embodiment, the air blower port 25 is movable between the first portion and the second portion by the wind direction actuator 27 (moving mechanism) under the control of the armrest ECU 22. The armrest ECU 22 moves the air blower port 25 to the first portion when the electrostatic sensor 21g detects the hand 72 of the passenger, and moves the air blower port 25 to the second portion when the electrostatic sensor 21h detects the hand 72 of the passenger.

In the above embodiment, the pattern of the air sent out from the air blower port 25 when the proximity flag H becomes 1 is not changed with the detection result of the electrostatic sensor A, whereas the present disclosure is not limited thereto. For example, the armrest ECU 22 may change the pattern of the air sent out from the air blower port 25 in accordance with the detection result of the electrostatic sensor 21. In one example, the armrest ECU 22 can change the air sent out from the air blower port 25 in the first pattern when the detection result of the electrostatic sensor 21a is the first detection result, and can change the air sent out from the air blower port 25 in the second pattern when the detection result of the electrostatic sensor 21a is the second detection result. The first detection result may be a result of hover detection of part of the body, and the second detection result may be a result of touch detection of part of the body. Hereinafter, a case where the above-described first detection result is a result of hover detection of part of the body and the above-described second detection result is a result of touch detection of part of the body will be described as an example.

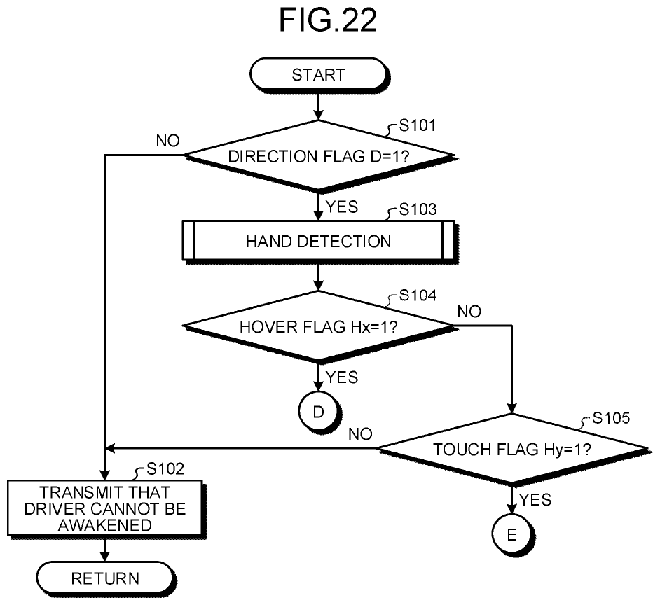

The procedure of the air blowing processing in this case is similar to that in the above-described embodiment and is similar to the flow in FIG. 10, but the content of the awakening operation control in Step S23 in FIG. 10 is different. The awakening operation control in Step S23 will be described with reference to FIGS. 22 to 25.

FIG. 22 illustrates processing of checking the position of the hand 72, and the basic processing flow is similar to the flow of FIG. 15. As illustrated in FIG. 22, first, the armrest ECU 22 determines whether the direction flag D is 1 (Step S101). A case where the direction flag D is not 1 (Step S101: No) indicates that the hand 72 cannot be followed. In this case, the armrest ECU 22 transmits, to the driving control ECU 2, a signal indicating that the driver cannot be awakened (Step S102).

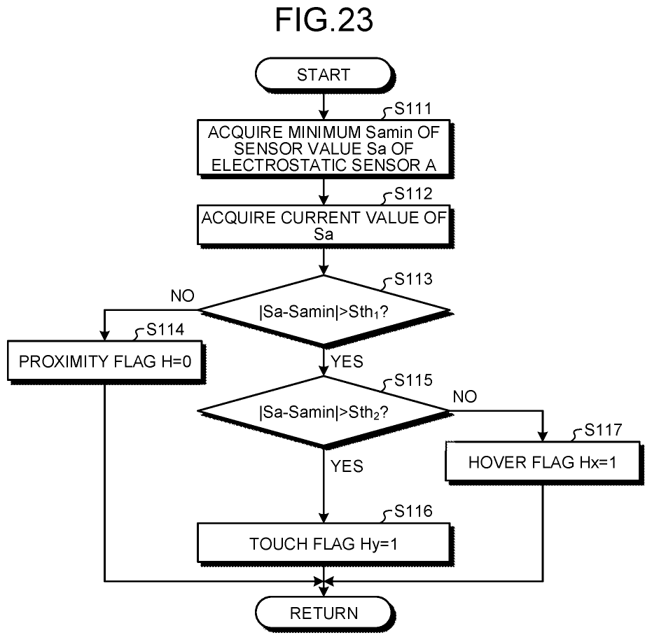

In a case where the direction flag D is 1 (Step S101: Yes), the armrest ECU 22 performs a hand detection processing (Step S103). Hereinafter, details of the hand detection processing in Step S103 of FIG. 22 will be described with reference to FIG. 23.

FIG. 23 is a flowchart illustrating a procedure of hand detection processing. The basic flow is similar to the flowchart illustrated in FIG. 13. The electrostatic sensor 21a will be described as an electrostatic sensor A. The armrest ECU 22 acquires a value Samin (value at power-on) that is the minimum value of a value Sa of the electrostatic sensor A (Step S111). Note that the armrest ECU 22 may store in advance the value Samin of the electrostatic sensor A in the memory 223 and acquire the stored value Samin.

The armrest ECU 22 acquires the current value Sa of the electrostatic sensor A (Step S112). Subsequently, the armrest ECU 22 determines whether the absolute value of the difference between the value Sa and the value Samin exceeds the first threshold value Sth1 (Step S113). In a case where the determination result of Step S113 is negative (Step S113: No), the armrest ECU 22 sets the proximity flag H to 0 (Step S114). On the other hand, in a case where the determination result of Step S113 is affirmative (Step S113: Yes), the armrest ECU 22 determines whether the absolute value of the difference between the value Sa and the value Samin exceeds a second threshold value Sth2 larger than the first threshold value Sth1 (Step S115).

In a case where the determination result of Step S115 is affirmative (Step S115: Yes), the armrest ECU 22 determines that it is touch detection in which the hand 72 touches the electrostatic sensor A. In this case, the armrest ECU 22 sets the touch flag Hy to 1 (Step S116). On the other hand, in a case where the determination result of Step S115 is negative (Step S115: No), the armrest ECU 22 determines that it is hover detection in which the hand 72 is not in contact with but in proximity to the electrostatic sensor A. In this case, the armrest ECU 22 sets the hover flag Hx to 1 (Step S117). The details of the hand detection processing procedure in Step S102 in FIG. 22 have been described above.

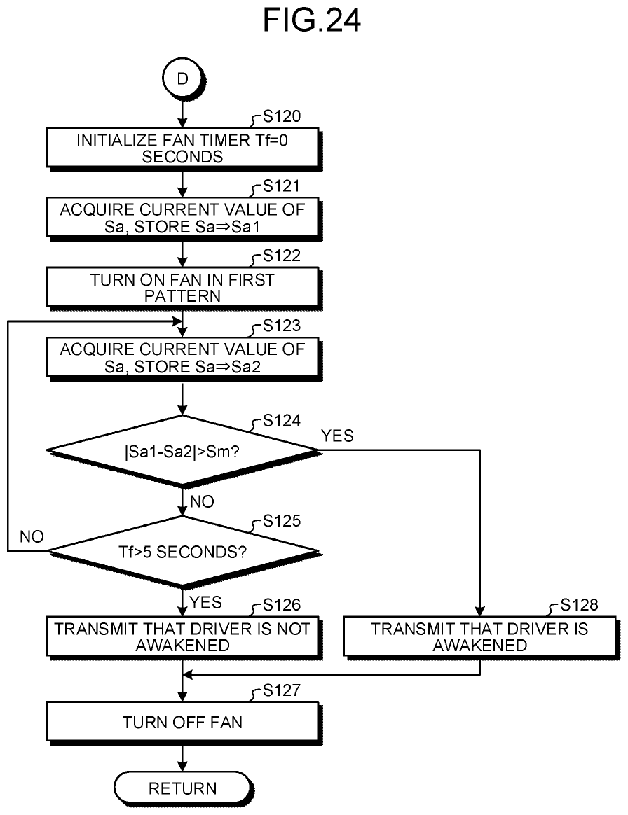

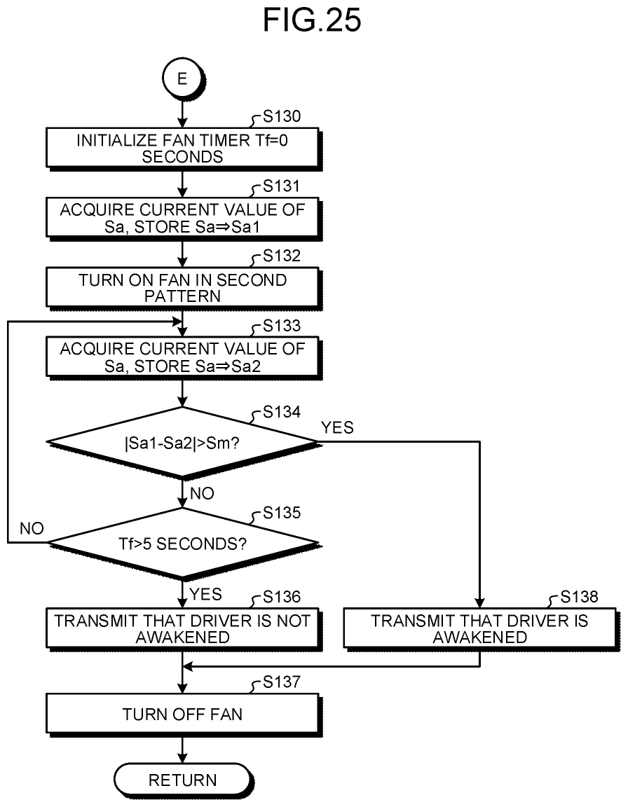

Returning to FIG. 22, the description will be continued. When the hover flag Hx is 1 as a result of the hand detection processing in Step S103 (Step S104: Yes), the armrest ECU 22 proceeds to the flow illustrated in FIG. 24 described later. On the other hand, when the touch flag Hy is 1 (Step S105: Yes), the process proceeds to the flow illustrated in FIG. 25 described later. When neither the hover flag Hx nor the touch flag Hy is 1 (Step S105: No), the process proceeds to Step S102 described above.

FIG. 24 is a flowchart illustrating an example of the procedure of the air blowing processing when the hover flag Hx is 1. The basic flow is similar to the flowchart illustrated in FIG. 16. The processing content of Step S122 is different from the processing content of Step S67 illustrated in FIG. 16.

In Step S120, the armrest ECU 22 initializes the fan timer Tf to 0 seconds (Step S120). Subsequently, the armrest ECU 22 acquires the current value of the value Sa, which is a value of the electrostatic sensor A, and then stores the current value as the value Sa1 (Step S121).

The armrest ECU 22 turns on the fan 26 (Step S122). At this time, the armrest ECU 22 operates the fan 26 such that the air sent out from the air blower port 25 changes in the first pattern corresponding to the hover flag Hx. Subsequently, the armrest ECU 22 acquires the current value of the value Sa and stores the acquired current value as the value Sa2 (Step S123). Subsequently, the armrest ECU 22 determines whether the absolute value of the difference value between the value Sa1 and the value Sa2 exceeds the value Sm (Step S124).

In a case where the absolute value of the difference value between the value Sa1 and the value Sa2 exceeds the value Sm (Step S124: Yes), the armrest ECU 22 transmits a signal indicating that the driver is awakened to the driving control ECU 2 (Step S128), and turns off the fan 26 (Step S127).

On the other hand, in a case where the absolute value of the difference value between the value Sa1 and the value Sa2 does not exceed the value Sm (Step S124: No), the armrest ECU 22 determines whether the fan timer Tf exceeds 5 seconds (Step S125). In Step S125, when the fan timer Tf does not exceed 5 seconds (Step S125: No), the processing returns to Step S123. In Step S125, when the fan timer Tf exceeds 5 seconds (Step S125: Yes), the armrest ECU 22 transmits to the driving control ECU 2 a signal indicating that the driver is not awakened (Step S126), and turns off the fan 26 (Step S127).

FIG. 25 is a flowchart illustrating an example of the procedure of the air blowing processing when the touch flag Hy is 1. The basic flow is similar to the flowchart illustrated in FIG. 16. The processing content of Step S132 is different from the processing content of Step S67 illustrated in FIG. 16.

In Step S130, the armrest ECU 22 initializes the fan timer Tf to 0 seconds (Step S130). Subsequently, the armrest ECU 22 acquires the current value of the value Sa, which is a value of the electrostatic sensor A, and stores the current value as the value Sa1 (Step S131).

The armrest ECU 22 operates the fan 26 (Step S132). At this time, the armrest ECU 22 operates the fan 26 such that the air sent out from the air blower port 25 changes in the second pattern corresponding to the touch flag Hy. For example, the second pattern may have a larger air volume than the first pattern. This is because, a state where the hand 72 completely touches the electrostatic sensor A (when the touch flag Hy=1) is assumed that the driver DR dozes off or the like, and it is preferable to perform a stronger awakening operation. The present disclosure is not limited thereto. The first pattern may have, for example, a larger air volume than the second pattern contrary to the above. This is because the hand 72 in the case of the hover flag Hx=1 corresponding to the first pattern is farther from the electrostatic sensor A than the hand 72 in the case of the touch flag Hy=1 corresponding to the second pattern, and thus it is assumed that it is difficult to feel the wind in the hand 72 unless the wind is intensified.

Subsequently, the armrest ECU 22 acquires the current value of the value Sa, and stores the acquired current value as the value Sa2 (Step S133). Subsequently, the armrest ECU 22 determines whether the absolute value of the difference value between the value Sa1 and the value Sa2 exceeds the value Sm (Step S134).

In a case where the absolute value of the difference value between the value Sa1 and the value Sa2 exceeds the value Sm (Step S134: Yes), the armrest ECU 22 transmits a signal indicating that the driver is awakened to the driving control ECU 2 (Step S138), and turns off the fan 26 (Step S137).

On the other hand, in a case where the absolute value of the difference value between the value Sa1 and the value Sa2 does not exceed the value Sm (Step S134: No), the armrest ECU 22 determines whether the fan timer Tf exceeds 5 seconds (Step S135). In Step S135, if the fan timer Tf does not exceed 5 seconds (Step S135: No), the process returns to Step S133. In Step S135, if the fan timer Tf exceeds 5 seconds (Step S135: Yes), the armrest ECU 22 transmits a signal indicating that the driver is not awakened to the driving control ECU 2 (Step S136), and turns off the fan 26 (Step S137).

A computer program executed by the armrest ECU 22 of the present embodiment is recorded as a data file in an installable format or an executable format, and is provided by being recorded on a computer-readable recording medium such as an optical recording medium such as a digital versatile disk (DVD), a USB memory, or a semiconductor memory device such as a solid state disk (SSD).

Moreover, the program executed by the armrest ECU 22 of the present embodiment may be configured to be stored on a computer connected to a network such as the Internet and provided by being downloaded via the network. Moreover, the program executed by the armrest ECU 22 of the present embodiment may be provided or distributed via a network such as the Internet.

Moreover, the program of the armrest ECU 22 of the present embodiment may be provided by being incorporated in advance in a ROM or the like.

Although the embodiments of the present disclosure have been described above, the above-described embodiments have been presented as examples, and are not intended to limit the scope of the invention. These novel embodiments can be implemented in various other forms, and various omissions, substitutions, and changes can be made without departing from the gist of the invention. These novel embodiments and modifications thereof are included in the scope and gist of the invention, and are included in the invention described in the claims and the equivalent scope thereof. Moreover, the components of different embodiments and modifications may be appropriately combined.

Moreover, the effects of the embodiments described in the present specification are merely examples and are not limited, and other effects may be provided.

According to the vehicle of the present disclosure, it is possible to appropriately give an awakening stimulus to an occupant.

What is claimed is:

1. A vehicle comprising:
a pair of first wheels;
a pair of second wheels;
a vehicle body coupled to the pair of first wheels and the pair of second wheels, the vehicle body being movable in a traveling direction by the pair of first wheels and the pair of second wheels;
a seat provided inside the vehicle body;
an armrest disposed along a side portion of the seat and disposed in the traveling direction, the armrest including an upper surface on which an arm of a passenger sitting on the seat is allowed to rest;
a sensor provided on a side surface of the armrest, the sensor being configured to detect a hand of the passenger; and
an air blower port provided on the side surface of the armrest and provided between the sensor and the upper surface of the armrest, the air blower being configured to send out air from the armrest, wherein
the vehicle is configured to change the air sent out from the air blower port on the basis of at least a detection result of the sensor.

2. The vehicle according to claim 1, wherein
the seat is a first seat,
the vehicle further comprises a second seat, and
the armrest is disposed between the first seat and the second seat in the traveling direction.

3. The vehicle according to claim 1, further comprising a door beside the seat,
wherein the armrest is disposed on the door.

4. The vehicle according to claim 1, further comprising an air blower mechanism configured to supply air from the inside of the armrest to the air blower port.

5. The vehicle according to claim 4, further comprising a control circuit configured to operate the air blower mechanism on the basis of a detection result of the sensor.

6. The vehicle according to claim 1, wherein the side surface of the armrest, on which the air blower port and the sensor are provided, is a surface located at a front end of the armrest in the traveling direction.

7. The vehicle according to claim 1, wherein the side surface of the armrest, on which the air blower port and the sensor are provided, is a surface of the armrest extending in the traveling direction.

8. The vehicle according to claim 1, further comprising a moving mechanism configured to move the air blower port between a first portion and a second portion, the first portion being a front end portion of the armrest in the traveling direction, the second portion being a portion of the armrest extending in the traveling direction, wherein
the sensor includes a first sensor provided in the first portion and a second sensor provided in the second portion,
the moving mechanism is configured to
move the air blower port to the first portion when the first sensor detects a hand of the passenger, and
move the air blower port to the second portion when the second sensor detects the hand of the passenger.

9. The vehicle according to claim 1, further comprising a moving mechanism configured to move the air blower port between a first portion and a second portion, the first portion being a front end portion of the armrest in the traveling direction, the second portion being a portion of the armrest extending in the traveling direction, wherein
the sensor includes a third sensor and a fourth sensor, the third sensor being provided on a left side of the air blower port, the fourth sensor being provided on a right side of the air blower port, and
the moving mechanism is configured to move one of the third sensor and the fourth sensor, the one having detected a hand of a user.

10. The vehicle according to claim 1, wherein
the vehicle is switchable between automated driving and manual driving, and
the vehicle is configured to perform the change of the air sent out from the air blower port further on the basis of a timing at which the automated driving is switched to the manual driving.

11. The vehicle according to claim 1, wherein
the detection result of the sensor is a first detection result, and
the vehicle is configured to
change the air sent out from the air blower port on the basis of the first detection result of the sensor, and
estimate an awakening state of the passenger on the basis of a second detection result of the sensor subsequent to the first detection result.

12. The vehicle according to claim 1, wherein the vehicle is configured to
change the air sent out from the air blower port in a first pattern when the detection result of the sensor is a first detection result, and
change the air sent out from the air blower port in a second pattern when the detection result of the sensor is a second detection result.

13. The vehicle according to claim 12, wherein
the first detection result is a result of hover detection of part of a body, and
the second detection result is a result of touch detection of part of a body.

14. An armrest installed in a vehicle, the vehicle including a pair of first wheels, a pair of second wheels, a vehicle body, and a seat provided inside the vehicle body, the vehicle body being coupled to the pair of first wheels and the pair of second wheels, the vehicle body being movable in a traveling direction by the pair of first wheels and the pair of second wheels, the armrest being installable along a side portion of the seat and installable in the traveling direction, the armrest comprising:
an upper surface on which an arm of a passenger sitting on the seat is allowed to rest;
a sensor provided on a side surface of the armrest, the sensor being configured to detect a hand of the passenger; and
an air blower port provided on the side surface of the armrest and provided between the sensor and the upper surface of the armrest, the air blower being configured to send out air from the armrest, wherein
the armrest is configured to change the air sent out from the air blower port on the basis of at least a detection result of the sensor.

15. The armrest according to claim 14, wherein
the seat is a first seat,
the vehicle further includes a second seat, and
the armrest is disposed between the first seat and the second seat in the traveling direction.

16. The armrest according to claim 14, wherein
the vehicle body includes a door beside the seat, and
the armrest is disposed on the door.

17. The armrest according to claim 14, further comprising an air blower mechanism configured to supply air from the inside of the armrest to the air blower port.

18. The armrest according to claim 17, further comprising a control circuit configured to operate the air blower mechanism on the basis of a detection result of the sensor.

19. The armrest according to claim 14, wherein the side surface of the armrest, on which the air blower port and the sensor are provided, is a surface located at a front end of the armrest in the traveling direction.

20. The armrest according to claim 14, wherein the side surface of the armrest, on which the air blower port and the sensor are provided, is a surface of the armrest extending in the traveling direction.

21. The armrest according to claim 14, further comprising a moving mechanism configured to move the air blower port between a first portion and a second portion, the first portion being a front end portion of the armrest in the traveling direction, the second portion being a portion of the armrest extending in the traveling direction, wherein
the sensor includes a first sensor provided in the first portion and a second sensor provided in the second portion,
the moving mechanism is configured to
move the air blower port to the first portion when the first sensor detects a hand of the passenger, and
move the air blower port to the second portion when the second sensor detects the hand of the passenger.

22. The armrest according to claim 14, further comprising a moving mechanism configured to move the air blower port between a first portion and a second portion, the first portion being a front end portion of the armrest in the traveling direction, the second portion being a portion of the armrest extending in the traveling direction, wherein
the sensor includes a third sensor and a fourth sensor, the third sensor being provided on a left side of the air blower port, the fourth sensor being provided on a right side of the air blower port, and
the moving mechanism is configured to move one of the third sensor and the fourth sensor, the one having detected a hand of a user.

23. The armrest according to claim 14, wherein
the vehicle is switchable between automated driving and manual driving, and
the armrest is configured to perform the change of the air sent out from the air blower port further on the basis of a timing at which the automated driving is switched to the manual driving.

24. The armrest according to claim 14, wherein
the detection result of the sensor is a first detection result, and
the armrest is configured to
change the air sent out from the air blower port on the basis of the first detection result of the sensor, and
estimate an awakening state of the passenger on the basis of a second detection result of the sensor subsequent to the first detection result.

25. The armrest according to claim 14, wherein the armrest is configured to
change the air sent out from the air blower port in a first pattern when the detection result of the sensor is a first detection result, and
change the air sent out from the air blower port in a second pattern when the detection result of the sensor is a second detection result.

26. The armrest according to claim 25, wherein
the first detection result is a result of hover detection of part of a body, and
the second detection result is a result of touch detection of part of a body.
